(19) United States
(12) Patent Application Publication
(10) Pub. No.: US 2008/0140687 A1
(43) Pub. Date: Jun. 12, 2008

(54) SOCKET STRUCTURE SIMULTANEOUSLY SUPPORTING BOTH TOE AND ETHERNET NETWORK INTERFACE CARD AND METHOD OF FORMING THE SOCKET STRUCTURE

(76) Inventors: Soo Cheol OH, Daejeon (KR); Seong Woon KIM, Daejeon (KR)

Correspondence Address: LADAS & PARRY LLP, 224 SOUTH MICHIGAN AVENUE, SUITE 1600, CHICAGO, IL, 60604, US

(21) Appl. No.: 11/875,021

(22) Filed: Oct. 19, 2007

(30) Foreign Application Priority Data
Dec. 8, 2006 (KR) 10-2006-0124886

(51) Int. Cl. G06F 17/30

(52) U.S. Cl. 707/100; 707/E17.005

(57) ABSTRACT

A socket structure simultaneously supporting a Transmission Control Protocol/Internet Protocol (TCP/IP) offload engine and an Ethernet network interface card (NIC), the socket structure including: an NIC management module storing and managing pointer information with respect to a socket structure for supporting a Berkeley software distribution (BSD) socket interface; and a TCP/IP offload engine (TOE) management module storing and managing identification information with respect to a socket directly managed by TOE hardware.

### CROSS-REFERENCE TO RELATED APPLICATIONS

This application claims the priority of Korean Patent Application No. 10-2006-0124886 filed on Dec. 8, 2006, in the Korean Intellectual Property Office, the disclosure of which is incorporated herein by reference.

### BACKGROUND OF THE INVENTION

1. Field of the Invention

The present invention relates to a socket used in a computer communication, and more particularly, to a socket structure capable of simultaneously supporting a Transmission Control Protocol/Internet Protocol (TCP/IP) offload engine and an Ethernet network interface card (NIC).

This work was supported by the IT R&D program of MIC/IITA [2005-S-405-02, A Development of the Next Generation Internet Server Technology]

2. Description of the Related Art

Transmission Control Protocol/Internet Protocol (TCP/IP), which are most generally used communication protocols between computers, are generally processed in a central processing unit (CPU) of a computer system and transmitted to an external network via an Ethernet network interface card (NIC). However, as networks have been developed to a level of gigabytes, not only it is difficult to process a large amount of TCP/IP protocols by a CPU but also performance of the entire computer system is also dropped.

To remove such loads, TCP/IP offload Engines (TOEs) have been provided, which process TCP/IP by using a network adapter instead of a CPU. Accordingly, The CPU may concentrate upon original calculating operations by applying TOEs, thereby improving performance of the entire computer system.

FIG. 1 is a schematic diagram for comparing a case of using a general network interface card (NIC) with a case using a TOE.

Referring to FIG. 1, when comparing with the case of using a general NIC, in the case of using a TOE, a TCP layer and an IP layer are built in hardware. That is, the protocols are process in the hardware. As described above, the TOE is used when transmitting and receiving a large amount of data from a high performance server to a network, thereby reducing loads on a host processor.

To perform a communication in a computer system, a socket performing as an end point of the communication is formed and the communication is performed using a socket interface. In the case of a Linux system, Berkelely Software Distribution (BSD) socket and a BSD interface are used.

FIG. 2 is a diagram illustrating a structure of a BSD socket used in Linux.

Referring to FIG. 2, the BSD socket is formed of a socket structure 100 and a sock structure 200. The socket structure 100 has general data required in a communication using a socket and is independent from a specific protocol such as TCP/IP. The sock structure 200 has data required in a communication using TCP/IP and is dependent on TCP/IP. Accordingly, all kinds of data required to process TCP/IP are stored in the sock structure 200. In Linux, when a command of forming a socket required in a TCP/IP communication occurs, the socket structure 100 and the sock structure are formed, an sk that is a member of the socket structure 100 is allowed to indicate the sock structure 200, and an sk_socket that is a member of the sock structure 200 is allowed to indicate the socket structure 100.

Since designed without considering TOEs, the BSD socket is incapable of supporting TOEs. Accordingly, to use a TOE in a conventional Linux system, a socket only for the TOE, which is not a BSD socket, is formed and an interface only for the TOE is designed and used. Since the socket is capable of supporting the TOE, it is not possible to simultaneously support the TOE and an Ethernet NIC.

Also, since using the interface only for the TOE instead of most generally used BSD socket interface, all network application programs formed based on a conventional BSD socket interface should be modified and recompiled by using an interface only for the TOE.

Also, since the socket and interface only for the TOE are developed depending on a specific TOE, there is not provided compatibility with respect to different types of TOEs.

### SUMMARY OF THE INVENTION

An aspect of the present invention provides a socket structure and a method of the same, the structure simultaneously supporting a Transmission Control Protocol/Internet Protocol (TCP/IP) offload engine and an Ethernet network interface card (NIC).

An aspect of the present invention also provides a socket structure and a method of the same, the structure simultaneously supporting a TCP/IP offload engine (TOE) and an Ethernet NIC without modifying an existing application program or socket interface.

An aspect of the present invention also provides a method of selecting a suitable one of a TOE and an Ethernet NIC at a point in time of performing a communication.

According to an aspect of the present invention, there is provided a socket structure simultaneously supporting a TOE and an Ethernet NIC, the socket structure including: an NIC management module storing and managing pointer information with respect to a socket structure for supporting a Berkeley software distribution (BSD) socket interface; and a TCP/IP offload engine (TOE) management module storing and managing identification information with respect to a toenic_sock directly managed by TOE hardware.

The socket structure may further include a socket management module storing and managing information on whether a management socket newly formed to perform a communication is bound to which one of an Ethernet NIC and TOE and information on a number of a port to which the management socket is bound.

The socket structure may further include a destination management module storing and managing Internet Protocol information of a destination socket set to be connected to perform an actual communication using TCP and port number information of the destination socket.

According to another aspect of the present invention, there is provided a method of forming a socket structure simultaneously supporting a TOE and an Ethernet NIC, the method including: forming a socket structure according to a BSD socket forming request using a socket forming function in an application program; forming and linking a management socket structure to indicate the socket structure; checking whether the Ethernet NIC is installed in addition to the TOE in a computer system, forming a sock structure for the Ethernet NIC when there is installed the Ethernet NIC, and setting such that the socket structure indicates the sock structure by using a pointer; and registering an address of a main memory storing the management socket structure and the socket structure, in a hash table.

According to another aspect of the present invention, there is provided a communication method using a socket structure simultaneously supporting a TOE and an Ethernet NIC, the method comprising: calculating a position of an address of the socket structure, in a hash table, by using a hash function; searching the address of the socket structure based on a calculated position value; and checking an address of a management socket structure from a pair of addresses corresponding to the address.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic diagram for comparing a case of using a general network interface card (NIC) with a case using a Transmission Control Protocol/Internet Protocol (TCP/IP) offload engine;

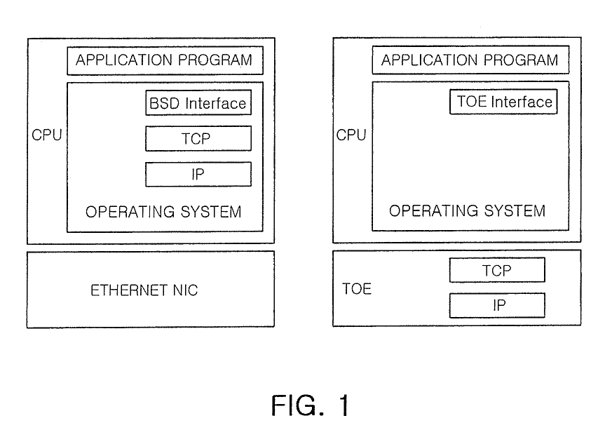

FIG. 2 is a diagram illustrating a structure of a Berkeley software distribution (BSD) socket used in Linux;

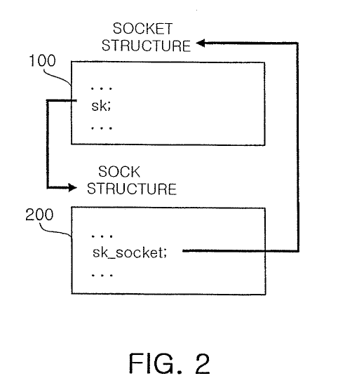

FIG. 3 is a configuration diagram illustrating a socket capable of simultaneously supporting the TCP/IP offload engine (TOE) and the Ethernet NIC according to an embodiment of the present invention;

FIG. 4 is a diagram illustrating a relationship between socket structures for simultaneously supporting the TOE and the Ethernet NIC according to another embodiment of the present invention;

FIG. 5 is a flowchart illustrating a process of forming a socket structure for simultaneously supporting the TOE and the Ethernet NIC according to another embodiment of the present invention;

FIG. 6 is a diagram illustrating an example of a hash table in which a management socket structure and the socket structure of FIG. 5 are stored and a linked list;

FIG. 7 is a flowchart illustrating a process of searching information of a management socket structure to perform a communication using the TOE via the socket structure of FIG. 5; and

FIG. 8 is a flowchart illustrating a process of selecting an NIC used for a communication via the socket structure of FIG. 5.

### DETAILED DESCRIPTION OF THE PREFERRED EMBODIMENT

Exemplary embodiments of the present invention will now be described in detail with reference to the accompanying drawings. Only, in describing operations of the exemplary embodiments in detail, when it is considered that a detailed description on related well-known functions or constitutions unnecessarily may make essential points of the present invention be unclear, the detailed description will be omitted. In the drawings, the same reference numerals are used throughout to designate the same or similar components.

Throughout the specification, when it is describe that a part is “connected to” another part, this includes not only a case of “being directly connected to” but also a case of “being electrically connected to, ˜ interposing another device therebetween”. Also, when it is described that a part “includes” an element and there is no opposite description thereof, this is not designate that the part excludes other elements but designates that the part may further include other elements.

Also, in the specification, the term of “a module” designates a single unit processing a certain function or operation, which can be embodied by one of hardware, software, and a combination thereof.

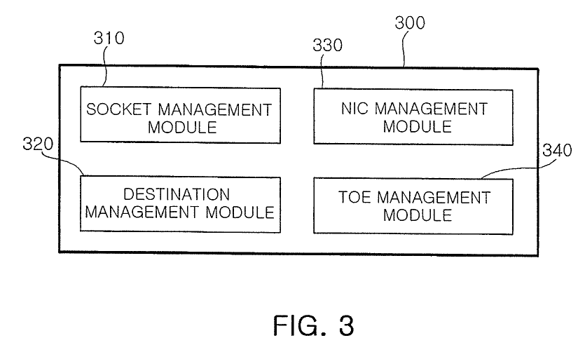

FIG. 3 is a configuration diagram illustrating a socket 300 capable of simultaneously supporting the Transmission Control Protocol/Internet Protocol (TCP/IP) offload engine and the Ethernet network interface card (NIC) according to an embodiment of the present invention.

Referring to FIG. 3, the socket 300 simultaneously supporting the TCP/IP off load engine (TOE) and the Ethernet NIC (hereinafter, referred to as “a management socket 300”) includes a socket management module 310, a destination management module 320, an NIC management module 330, and a TOE management module 340.

The socket management module 310 stores and manages information bind_nic on which one of the Ethernet NIC and the TOE a management socket newly formed to perform a communication is bound to and information bind_port on a number of a port to which the management socket is bound.

The destination management module 320 stores and manages IP address information dst_addr of an opponent socket set to be actually connected to a communication using a TCP and port number information dst_port of the opponent socket.

The NIC management module 330 stores and manages pointer information on a socket structure for supporting a BSD socket interface.

The TOE management module 340 stores and manages identification information toenic_sock_id with respect to a socket toenic_sock directly managed by TOE hardware. In a system using a TOE, a socket directly managed by TOE hardware exists in addition to a socket maintained in a main memory.

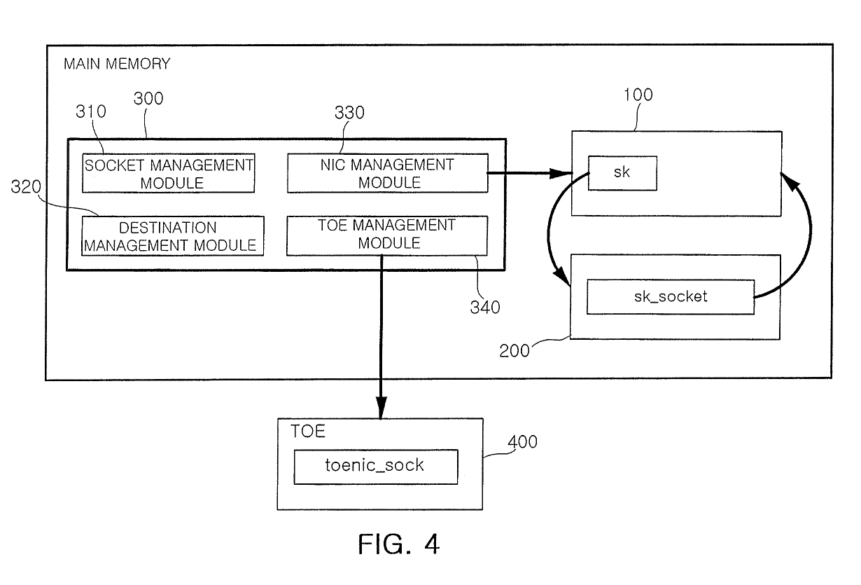

FIG. 4 is a diagram illustrating a relationship between socket structures for simultaneously supporting the TOE and the Ethernet NIC according to another embodiment of the present invention.

Referring to FIG. 4, as the socket structure simultaneously supporting the TOE and Ethernet NIC according to the present embodiment, there may be the socket structure 100, the sock structure 200, and the management socket structure 300.

The socket structure 100 is a structure for supporting a BSD socket interface, the sock structure 200 is used to the Ethernet NIC using the TCP/IP, and the management socket structure 300 stores information for simultaneously managing the TOE and Ethernet NIC.

The socket structure 100 indicates the sock structure 200 via an sk that is the member, and the sock structure 200 indicates the socket structure 100 via an sk_socket that is the member. In this case, the management socket structure 300 indicates the socket structure 100 by using a pointer managed by an NIC management module 330 and indicates a socket toenic_sock directly managed by a TOE hardware 400 based on identification information managed by the TOE management module 340.

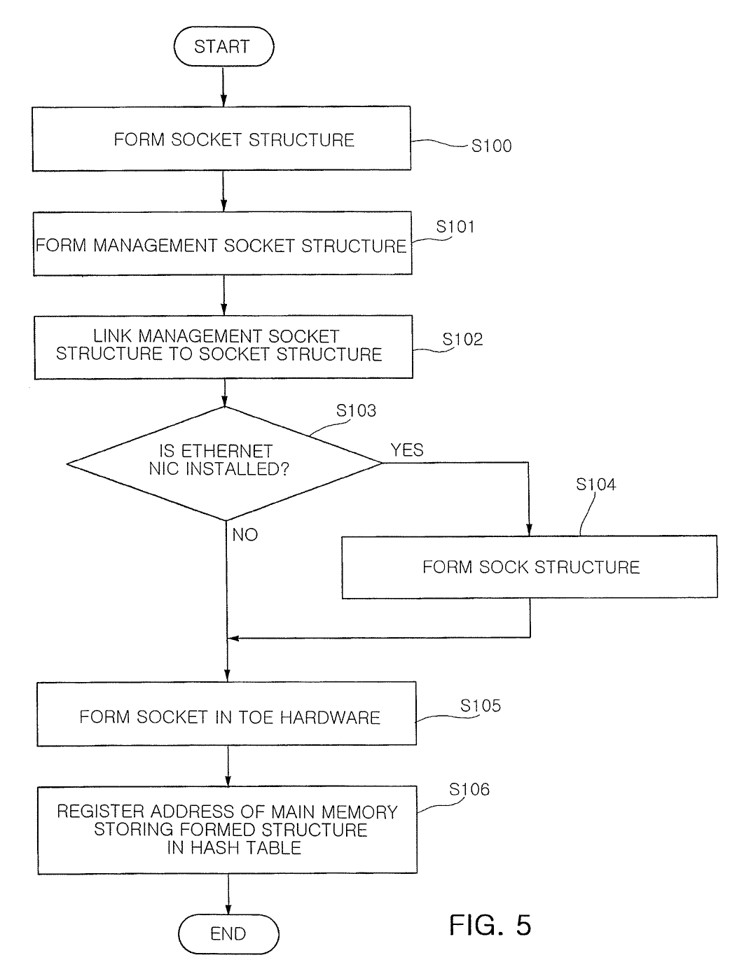

FIG. 5 is a flowchart illustrating a process of forming a socket structure for simultaneously supporting a TOE and Ethernet NIC according to another embodiment of the present invention.

Referring to FIG. 5, the socket structure is formed (S100). The socket structure is for supporting a BSD socket interface. When there is a request for forming a BSD socket using a socket forming function in an application program to perform a communication, the socket structure is formed via S100.

Then, when the socket structure is formed according to the request of the application program, a management socket structure is formed (S101), and the management socket structure is linked to indicate the socket structure formed in S100 (S102).

Next, it is checked whether the Ethernet NIC is installed in a computer system in addition to the TOE (S103). When the Ethernet NIC is installed, a sock structure for the Ethernet NIC is formed (S104). The socket structure formed in S100 is set to indicate the sock structure formed in S104 by using a pointer.

As a result of the checking in S103, when the Ethernet NIC is not installed in the computer system, the sock structure is not formed. Since there are present various computer systems, a TOE and Ethernet NIC may be simultaneously installed in a computer system, and the TOE may be installed in another computer system, without the Ethernet NIC. In the case of the computer system in which only the TOE is installed, it is unnecessary to form a sock structure used to process TCP/IP. Accordingly, when there is uninstalled an Ethernet NIC, the sock structure is not formed.

Next, a socket toenic_sock managed by TOE hardware is formed by transmitting a socket forming command to the TOE hardware (S105).

An address of a main memory storing the management socket structure and the socket structure is registered in a hash table as shown in FIG. 5 (S106). This is a process of registering the address of the main memory in which the management socket structure and the socket structure are stored. A location hash_id of the address of the main memory in the hash table is calculated by using the hash function, and a pair of addresses of the socket structure and the management socket structure, which are mapped as the same position hash-id in the hash table by the hash function, is used connected to each other by using as a linked list.

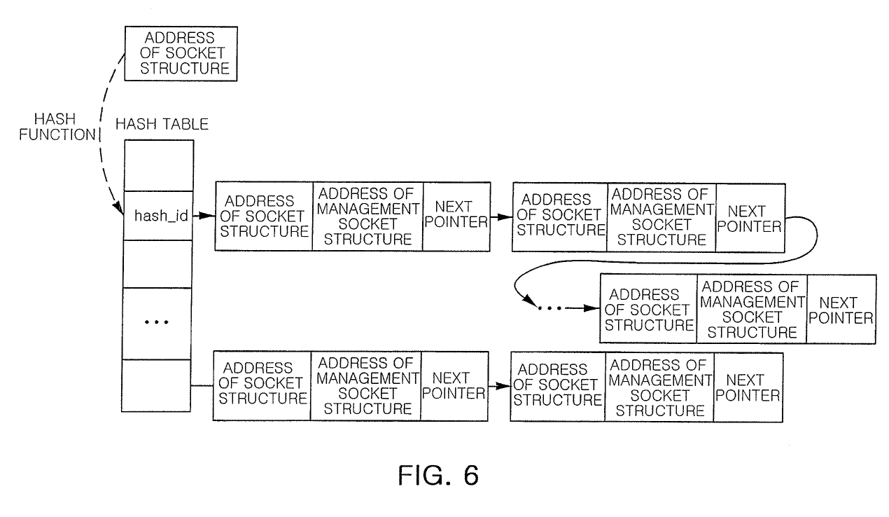

FIG. 6 is a diagram illustrating an example of the hash table in which a management socket structure and the socket structure of FIG. 5 are stored and the linked list.

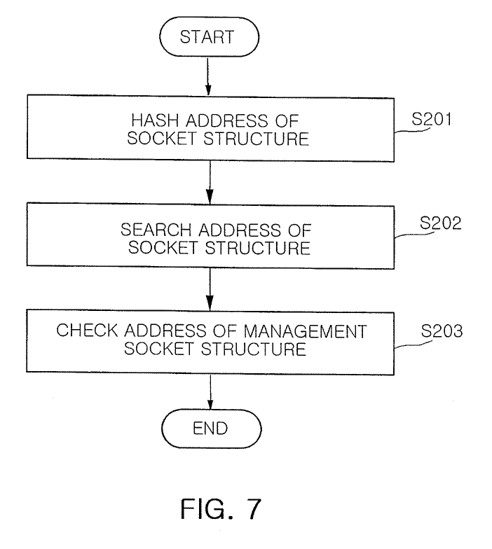

FIG. 7 is a flowchart illustrating a process of searching information of a management socket structure to perform a communication using the TOE via the socket structure formed according to another embodiment of the present invention. When a user program forms a socket and calls a socket interface, a socket structure is transferred to an input of the socket interface. Accordingly, to perform the communication using the TOE, a management socket structure indicating a specific socket structure should be found.

Referring to FIG. 7, a location hash-id of an address of the socket structure in a hash table is calculated by using a hash function (S201).

Next, an address of the socket structure is searched based on the location hash_id calculated in S201 (S202). In S202, a location corresponding to the location hash_id calculated in S201 is checked, a linked list connected to the location is searched, and then a pair of addresses having the same value as the socket structure is extracted from the linked list.

When the pair of addresses of the socket structure is searched via S202, an address of the management socket structure forming the pair of addresses is checked(S203).

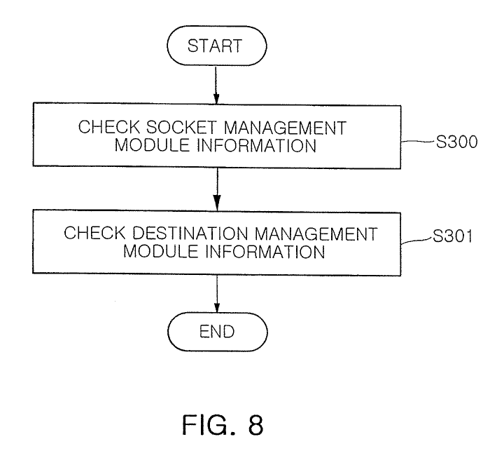

FIG. 8 is a flowchart illustrating a process of selecting an NIC used for a communication via the socket structure of FIG. 5.

When an application program searches a management socket structure corresponding to the socket structure to perform a communication, it should be determined which one of a TOE and Ethernet NIC is used to process a call with respect to a socket interface.

Referring to FIG. 8, socket management module information of the management socket structure is checked (S300). In this case, the socket management module stores and manages information bind_nic on which one of the Ethernet NIC and TOE a management socket newly formed to perform a communication is bound to, and information bind_port on a number of a port to which the management socket is bound.

In an exemplary embodiment of the present invention, when a plurality of NICs are installed in a system, a BSD interface determines which NIC is used to process a call with respect to a socket interface, depending on a state of binding a socket. That is, when the socket is bound to a certain NIC, the certain NIC where the socket is bound is used. In this case, information bind-nic on that which one of a TOE and Ethernet NIC the socket is bound is stored in a socket management module of the management socket structure. When one of the TOE and the Ethernet NIC is designated in the module, the call with respect to the socket interface is processed by using the designated TOE or Ethernet NIC.

When it is disclosed that a communication should be performed by using all types of NICs existing in the socket management module, for example, INADDR_ANY, information bind_port on a number of a port of the socket management module is referred. For this, a user may previously determine a port regulation of an NIC selection policy. When the number of the port exists in the port regulation of the previously determined NIC selection policy, one of a TOE and Ethernet NIC designated by the port regulation is used. For example, when an NIC selection policy such as “port 124 234 492 TOE” is set and a socket call with respect to a socket whose port number is 234 occurs, the communication is performed by using the TOE.

When an NIC for performing a communication is not determined in S300, destination management module information of a management socket structure is checked (S301). The destination management module stores and manages IP address information dst_addr of an opponent socket set to be connected to form an actual communication using a TCP and port number information dst_port of the opponent socket. For this, a user may previously determine one of a same network regulation and a different network regulation, as a selection policy with respect to the NIC.

When a network ID network_id of a computer system is identical to or different from a network ID network_id of a destination to which data are transmitted, the communication is performed by using one of a TOE and Ethernet NIC designated in one of the same network regulation and the different network regulation. The network ID network_id of the computer system is obtained from logical multiplying an IP address of one of the TOE by Ethernet NIC and a netmask. The network ID network_id of the destination to which data are transmitted is obtained from logical multiplying a destination address and the netmask.

When the network ID of the computer system is identical to that of the destination, the communication is performed by using one of the TOE and Ethernet NIC designated in the same network regulation. This indicates that the computer system and the destination to which data are transmitted exist in the same network such as an identical office, company, and building.

When the network ID of the computer system is different from that of the destination, the communication is performed by using one of the TOE and Ethernet NIC designated in the different network regulation. This indicates the computer system and the destination of the data do not exist in the same network but are far from each other.

In an exemplary embodiment of the present invention, though not shown in FIG. 8, when the NIC to be used in the communication is not determined via S300 and S301, a regulation in which both of the TOE and Ethernet NIC are capable of being used as the selection policy with respect to the NIC may be previously set by the user.

A conventional BSD socket supporting an Ethernet NIC is incapable of supporting a TOE. Since a management socket according to an exemplary embodiment of the present invention supports not only the Ethernet NIC but also the TOE, the TOE may be managed while being integrated with the conventional BSD socket and a BSD socket interface supporting the Ethernet NIC.

Also, according to the present invention, instead of designing a new interface for the TOE, the TOE may be used by using an existing BSD socket interface. Accordingly, it is not required to modify a general network application program to use the TOE.

Also, one of the TOE and Ethernet NIC may be dynamically selected without modifying a user program while performing the program.

While the present invention has been shown and described in connection with the exemplary embodiments, it will be apparent to those skilled in the art that modifications and variations can be made without departing from the spirit and scope of the invention as defined by the appended claims.

What is claimed is:

1. A socket structure simultaneously supporting a Transmission Control Protocol/Internet Protocol (TCP/IP) offload engine and an Ethernet network interface card (NIC), the socket structure comprising:
an NIC management module storing and managing pointer information with respect to a socket structure for supporting a Berkeley software distribution (BSD) socket interface; and
a TCP/IP offload engine (TOE) management module storing and managing identification information with respect to a toenic_sock directly managed by TOE hardware.

2. The socket structure simultaneously supporting a TOE and an Ethernet NIC of claim 1, further comprising a socket management module storing and managing information on whether a management socket newly formed to perform a communication is bound to which one of an Ethernet NIC and TOE and information on a number of a port to which the management socket is bound.

3. The socket structure simultaneously supporting a TOE and an Ethernet NIC of claim 1, further comprising a destination management module storing and managing Internet Protocol information of a destination socket set to be connected to perform an actual communication using TCP and port number information of the destination socket.

4. The socket structure simultaneously supporting a TOE and an Ethernet NIC of claim 1, wherein the socket structure managed by the NIC management module is a structure for supporting the BSD socket interface.

5. The socket structure simultaneously supporting a TOE and an Ethernet NIC of claim 4, wherein the socket structure indicates a sock structure for supporting an Ethernet NIC using TCP/IP via sk that is a member.

6. A method of forming a socket structure simultaneously supporting a TOE and an Ethernet NIC, the method comprising the operations of:
(a) forming a socket structure according to a BSD socket forming request using a socket forming function in an application program;
(b) forming and linking a management socket structure to indicate the socket structure;
(c) checking whether the Ethernet NIC is installed in addition to the TOE in a computer system, forming a sock structure for the Ethernet NIC when there is installed the Ethernet NIC, and setting such that the socket structure indicates the sock structure by using a pointer; and
(d) registering an address of a main memory storing the management socket structure and the socket structure, in a hash table.

7. The method of claim 6, further comprising forming a socket managed in TOE hardware by transmitting a socket forming command to the TOE hardware, between the operations (c) and (d).

8. The method of claim 6, wherein the operation (d) is calculated a position of the hash table corresponding to the address of a main memory storing the socket structure by using hash function, connected between the socket structure corresponding to the calculated position and the management socket structure by using a linked list.

9. A communication method using a socket structure simultaneously supporting a TOE and an Ethernet NIC, the method comprising:
calculating a position of an address of the socket structure, in a hash table, by using a hash function;
searching the address of the socket structure based on a calculated position value; and
checking an address of a management socket structure from a pair of addresses corresponding to the address.

10. The method of claim 9, further comprising checking the address of the management socket structure and processing a call for a socket interface by using an NIC to which a socket is bound.

11. The method of claim 10, further comprising processing a call for a socket interface by using an NIC corresponding to number information of a port to which the management socket is bound.
